(19) United States
(12) Patent Application Publication
(10) Pub. No.: US 2009/0067941 A1
(43) Pub. Date: Mar. 12, 2009

(54) CNC machine tool having a sliding member movable at a high speed

(75) Inventor: Feng-Tien Chen, Lung-Ching Hsiang (TW)

Correspondence Address: PILLSBURY WINTHROP SHAW PITTMAN, LLP, P.O. BOX 10500, MCLEAN, VA, 22102, US

(73) Assignee: Feng-Tien CHEN, Lung-Ching Hsiang (TW)

(21) Appl. No.: 12/149,883

(22) Filed: May 9, 2008

Related U.S. Application Data
(63) Continuation-in-part of application No. 11/896,987, filed on Sep. 7, 2007.

(51) Int. Cl. B23B 47/00

(52) U.S. Cl. 408/129

(57) ABSTRACT

A machine tool includes a machine body, a first sliding member movable on the machine body along a direction, and a second sliding member movable on the first sliding member along the direction. The first and second sliding members can be driven simultaneously to move on the machine body and the first sliding member, respectively, in the direction.

### CROSS-REFERENCE TO RELATED APPLICATION

This is a Continuation-in-Part (CIP) of U.S. patent application Ser. No. 11/896,987, filed on Sep. 7, 2007.

### BACKGROUND OF THE INVENTION

1. Field of the Invention

This invention relates to a machine tool, and more particularly to a CNC (Computer-Numerical-Controlled) machine tool.

2. Description of the Related Art

Referring to FIG. 1, a conventional CNC machine tool includes a machine body 1 consisting of a bottom seat 101 and a post member 102, a base 2 movable on the bottom seat 101 along a Y-axis direction, a worktable 3 movable on the base 2 along an X-axis direction, a driving unit 4 disposed on the post member 102, and a spindle seat 5 driven by the driving unit 4 to move on the post member 102 along a Z-axis direction. A workpiece (not shown) can be held on the worktable 3. The driving unit 4 includes a servomotor 401 and a threaded rod 402 driven by the servomotor 401 and journalled on the post member 102. The spindle seat 5 is movable vertically relative to the workpiece on the worktable 3 in response to rotation of the threaded rod 402.

The spindle seat 5 holds a cutter (not shown) for performing a cutting operation on the workpiece. When a first cutting operation is completed, a first cutter is removed from the workpiece, and is moved upwardly from a cutting position adjacent to the workpiece to a safety position by a first distance. Next, the first cutter is further moved upwardly to a cutter-exchanging position by a second distance. In the cutter-exchanging position, an automatic cutter-changing device (not shown) is operated to first remove the first cutter from the spindle seat 5 and subsequently move a second cutter onto the spindle seat 5. When the cutter-exchanging operation is completed, the second cutter is moved downwardly to the safety position by the second distance, and subsequently is further moved downwardly to the cutting position by the first distance for performing a subsequent cutting operation on the workpiece. Since the first and second cutters are moved on the post member 102 by only the spindle seat 5, a significant amount of time is necessary for such a cutter exchange operation, thereby reducing the production capacity of the CNC machine tool. Furthermore, the length of the threaded rod 402 and the height of the post member 102 are substantial due to such sole reliance on the spindle seat 5 for movement of the first and second cutters. As a result, the volume and the fabrication costs of the CNC machine tool are increased.

### SUMMARY OF THE INVENTION

The object of this invention is to provide a CNC machine tool that can overcome the above-mentioned drawbacks associated with the prior art.

According to an aspect of this invention, a machine tool comprises:

a machine body;

a first driving unit;

a first sliding member driven by the first driving unit to move on the machine body along a direction;

a second driving unit disposed between the first and second sliding members; and

a second sliding member driven by the second driving unit to move on the first sliding member along the direction.

According to another aspect of this invention, a machine tool comprises:

a machine body;

a first sliding member movable on the machine body along a direction;

a second sliding member movable on the first sliding member along the direction; and

a driving device including a motor, a first threaded rod extending along the direction and driven by the motor to rotate on the machine body, a second threaded rod parallel to the first threaded rod and disposed movably on the machine body, and a drive unit interconnecting the first and second threaded rods such that rotation of the first threaded rod relative to the machine body results in movement of the second sliding member on the first sliding member along the direction, the first sliding member engaging threadably the first threaded rod so that the motor is operable to drive simultaneous movement of the first and second sliding members on the machine body and the first sliding member, respectively, in the direction.

If a spindle unit is mounted on the second sliding member, when the first and second sliding members are driven simultaneously, the spindle unit will move on the machine body at a high speed. Thus, the production capability of the CNC machine tool can be increased.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a perspective view of a conventional CNC machine tool;

FIG. 2 is a perspective view of the first preferred embodiment of a CNC machine tool according to this invention;

FIG. 3 is a partly exploded perspective view of the first preferred embodiment;

FIG. 4 is a side view of the first preferred embodiment, illustrating how an automatic cutter-changing device is mounted thereto;

FIG. 5 is a partly sectional view of the first preferred embodiment when a spindle unit is disposed in a cutter-exchanging position;

FIG. 6 is a partly sectional view of the first preferred embodiment when the spindle unit is disposed in a cutting position;

FIG. 7 is a perspective view of the second preferred embodiment of a CNC machine tool according to this invention;

FIG. 8 is a front view of the third preferred embodiment of a CNC machine tool according to this invention;

FIG. 9 is a sectional view of the third preferred embodiment;

FIG. 10 is a perspective view of the fourth preferred embodiment of a CNC machine tool according to this invention;

FIG. 11 is a partly sectional view of the fourth preferred embodiment;

FIG. 12 is a fragmentary sectional view of the fourth preferred embodiment taken along Line XII-XII in FIG. 11;

FIG. 13 is a partly exploded front perspective view of the fifth preferred embodiment of a CNC machine tool according to this invention;

FIG. 14 is a schematic assembled rear perspective view of the fifth preferred embodiment;

FIG. 15 is a rear perspective view of a second sliding member of the fifth preferred embodiment;

FIG. 16 is a sectional side view of the fifth preferred embodiment;

FIG. 17 is a fragmentary sectional side view of the fifth preferred embodiment, illustrating a drive unit;

FIG. 18 is a schematic view illustrating engagement between first and second gears of the drive unit of the fifth preferred embodiment;

FIG. 19 is a sectional side view of the fifth preferred embodiment, illustrating simultaneous movement of first and second sliding members on a machine body and the first sliding member, respectively;

FIG. 20 is a sectional side view of the sixth preferred embodiment of a CNC machine tool according to this invention;

FIG. 21 is a fragmentary sectional side view of the sixth preferred embodiment, illustrating a modified drive unit; and

FIG. 22 is a schematic view of the modified drive unit of the sixth preferred embodiment.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

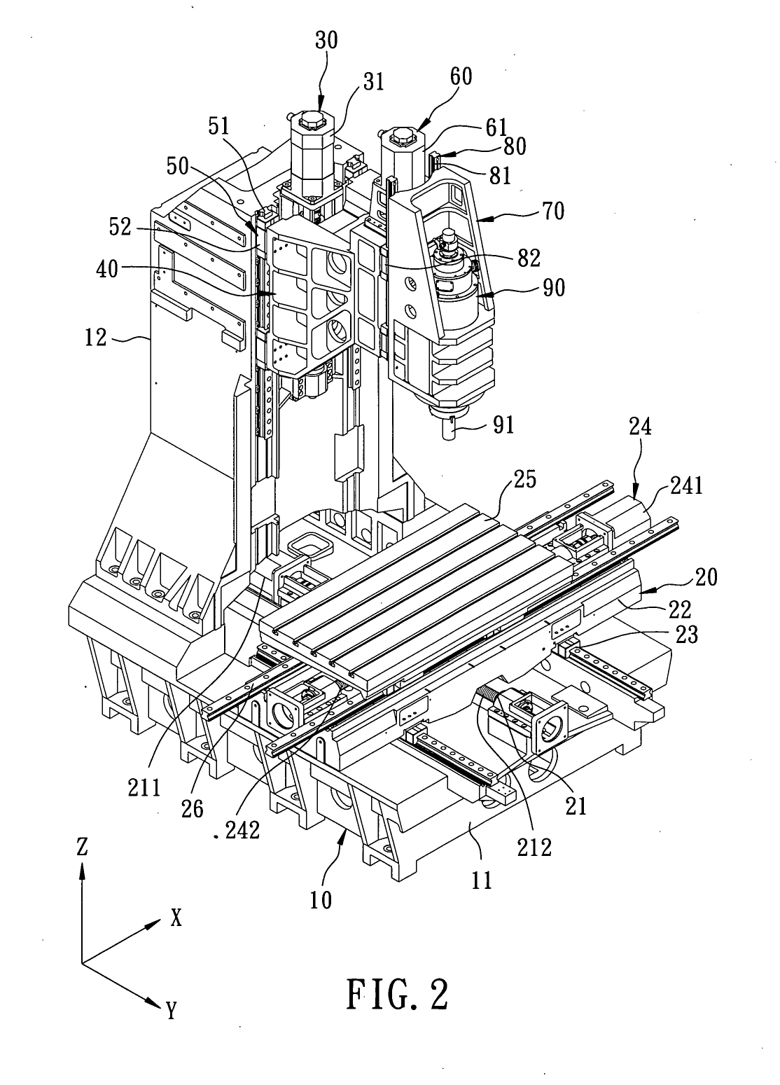

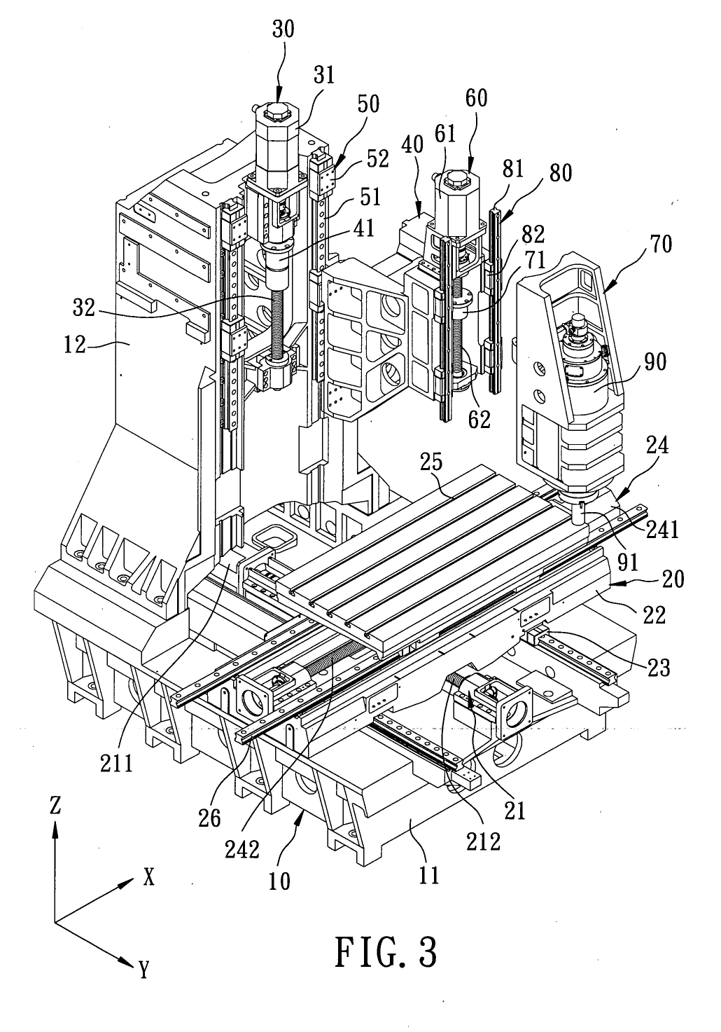

Referring to FIGS. 2, 3, and 4, the first preferred embodiment of a CNC machine tool according to this invention includes a machine body 10, a worktable unit 20, a first driving unit 30 disposed on the machine body 10, a first sliding member 40 disposed on the machine body 10, a first linear rail unit 50 disposed between the machine body 10 and the first sliding member 40, a second driving unit 60 disposed on the first sliding member 40, a second sliding member 70 disposed on the first sliding member 40, a second linear rail unit 80 disposed between the first and second sliding members 40, 70, and a spindle unit 90 disposed on the second sliding member 70.

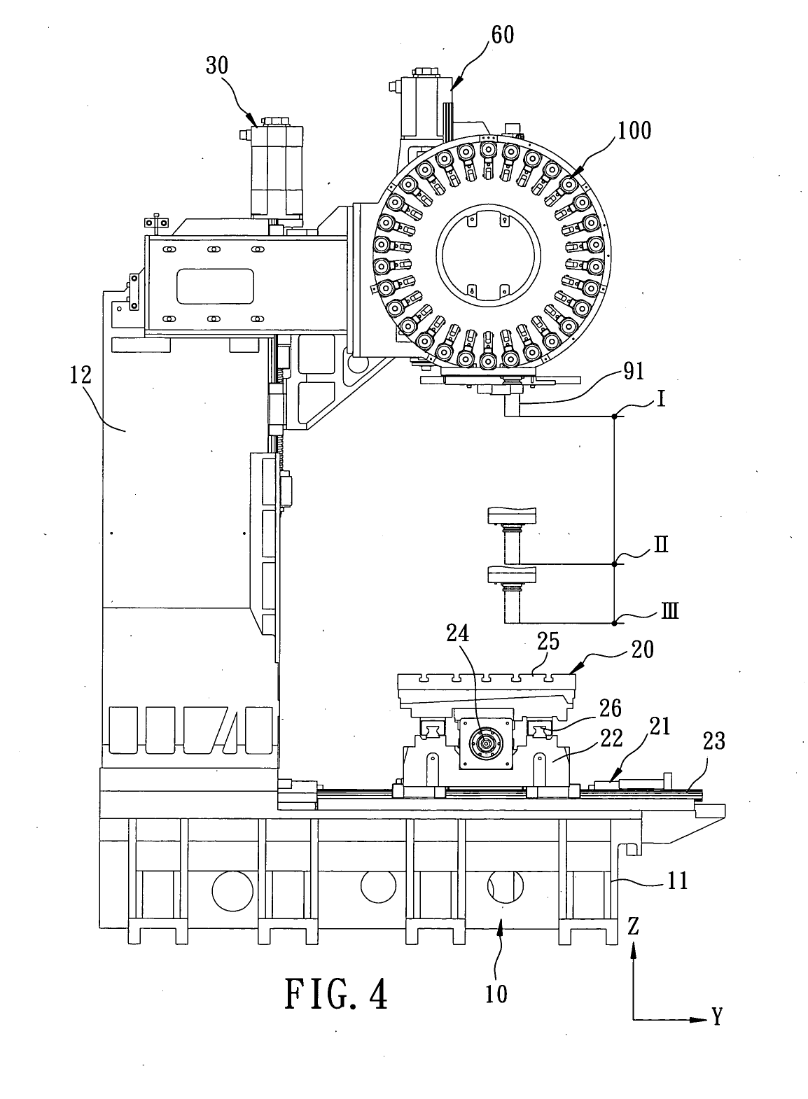

The machine body 10 includes a bottom seat 11 and a post member 12 fixed on and extending upwardly from the bottom seat 11 along a Z-axis direction. In this embodiment, the Z-axis direction is a vertical direction. An automatic cutter-changing device 100 (see FIG. 4) can be mounted to a top end of the post member 12.

The worktable unit 20 includes a Y-direction driving unit 21 disposed on the bottom seat 11, a Y-direction sliding member 22 movable on the bottom seat 11 along a Y-axis direction, a Y-direction linear rail unit 23 disposed between the bottom seat 11 and the Y-direction sliding member 22, an X-direction driving unit 24 disposed on the Y-direction sliding member 22, a worktable 25 disposed on the Y-direction sliding member 22, and an X-direction linear rail unit 26 disposed between the Y-direction sliding member 22 and the worktable 25. The Y-direction driving unit 21 includes a servomotor 211 and a Y-direction threaded rod 212 journalled on a top portion of the bottom seat 11 and driven by the servomotor 211 to rotate. The Y-direction threaded rod 212 extends along the Y-axis direction. The X-direction driving unit 24 includes a servomotor 241 and an X-direction threaded rod 242 journalled on a top portion of the Y-direction sliding member 22 and driven by the servomotor 241 to rotate. The servomotor 211 is operable to rotate the Y-direction threaded rod 212 to thereby move the worktable 25 forwardly and rearwardly relative to the post member 12 along the Y-axis direction. The servomotor 241 is operable to rotate the X-direction threaded rod 242 to thereby move the worktable 25 leftwardly and rightwardly relative to the post member 12 along an X-axis direction.

The first driving unit 30 includes a first servomotor 31 and a first threaded rod 32 journalled on the post member 12 and driven by the first servomotor 31 to rotate. The first threaded rod 32 extends along the Z-axis direction.

The first sliding member 40 is disposed on a front surface of the post member 12, and includes a fixed first internal thread member 41 engaging the first threaded rod 32. The first sliding member 40 is driven by the first driving unit 30 to move vertically relative to the post member 12 along the Z-axis direction.

The first linear rail unit 50 includes two parallel first slide rails 51 disposed fixedly on the front surface of the post member 12 and extending along the Z-axis direction, and two first sliding block units disposed fixedly on a rear surface of the first sliding member 40 and slidable respectively along the first slide rails 51. In this embodiment, each of the first sliding block units consists of two first sliding blocks 52, each of which is connected to the corresponding slide rail 51 by a dovetail tongue and groove engagement.

The second driving unit 60 includes a second servomotor 61 and a second threaded rod 62 journalled on a front surface of the first sliding member 40 and driven by the second servomotor 61 to rotate. The second threaded rod 62 extends along the Z-axis direction. The first and second driving units 30, 60 are capable of being operated simultaneously.

The second sliding member 70 includes a second internal thread member 71 engaging the second threaded rod 62. Upon simultaneous operation of the first and second driving units 30, 60, the first sliding member 40 is moved on the post member 12, and the second sliding member 70 is moved on the first sliding member 40. Hence, the spindle unit 90 can move relative to the worktable 25 along the Z-axis direction at a high speed.

The second linear rail unit 80 includes two parallel second slide rails 81 fixed on a rear surface of the second sliding member 70 and extending along the Z-axis direction, and two second sliding block units disposed fixedly on a front surface of the first sliding member 40 and slidable respectively along the second slide rails 81. In this embodiment, each of the second sliding block units consists of two second sliding blocks 82.

The spindle unit 90 extends along the Z-axis direction, and has a bottom portion mounted with a cutter 91 for performing a cutting operation on a workpiece (not shown) held on the worktable 25.

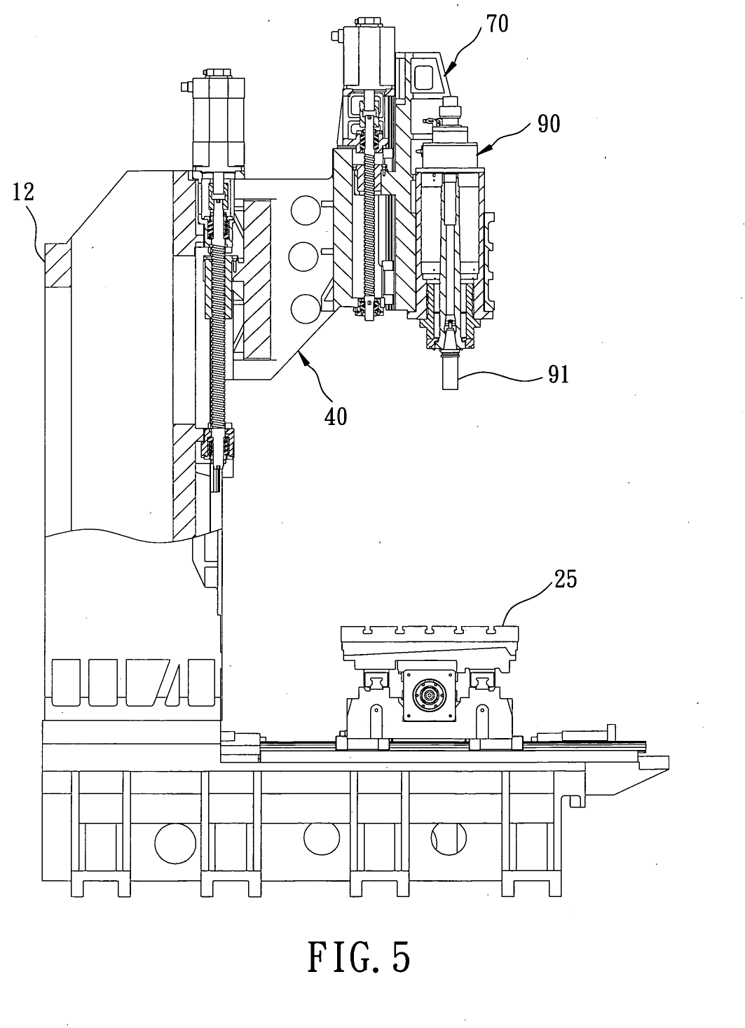

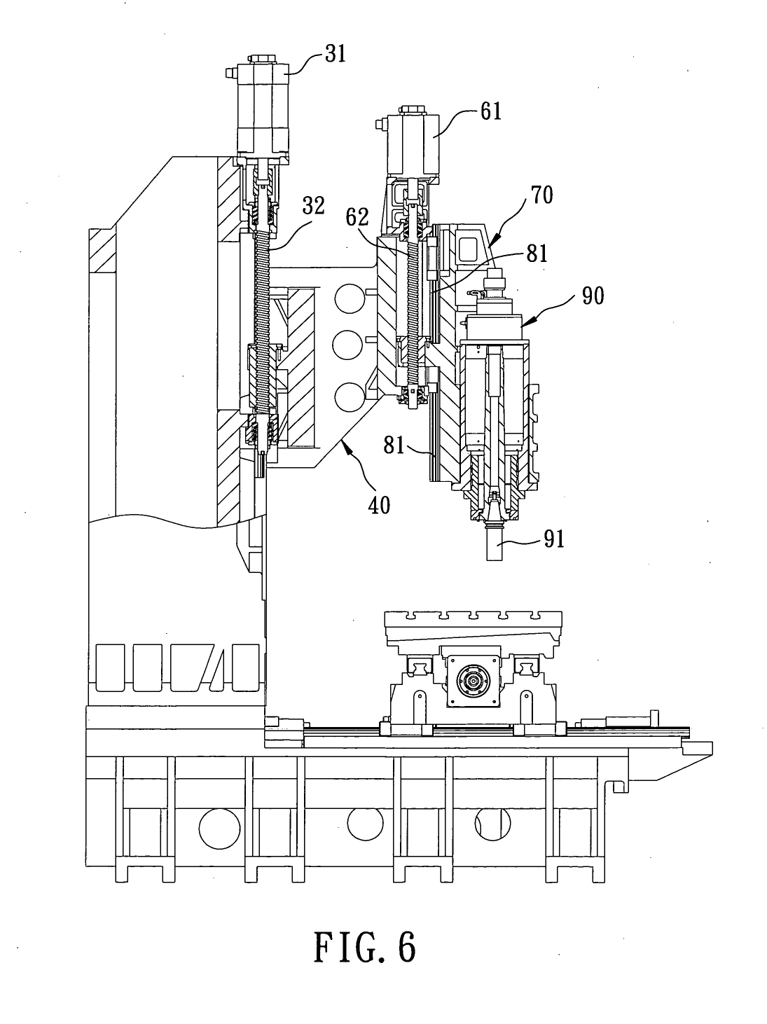

As such, with particular reference to FIG. 4, by simultaneous operation of the first and second driving units 30, 60, the cutter 91 is movable along the Z-axis direction among a cutter-changing position (I) shown in FIG. 5, a safety position (II), and a cutting position (III) shown in FIG. 6. In the cutter-changing position (I), with particular reference to FIG. 5, the first sliding member 40 is disposed in an upper limit position relative to the post member 12, and the second sliding member 70 is disposed in an upper limit position relative to the first sliding member 40. In the cutting position, with particular reference to FIG. 6, the first sliding member 40 is disposed in a lower limit position relative to the post member 12, and the second sliding member 70 is disposed in a lower limit position relative to the first sliding member 40.

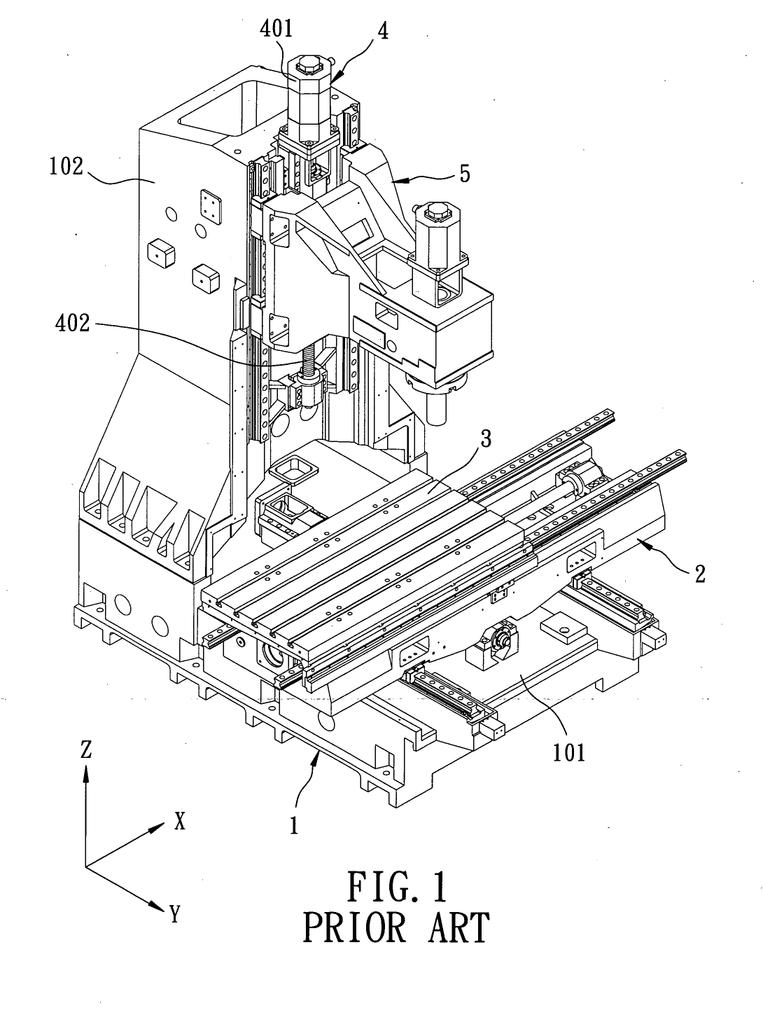

In view of the above, the CNC machine tool of this invention has the following advantages:
(1) The cutter 91 can be moved along the Z-axis direction at a high speed, thereby promoting the production capability of the CNC machine tool, such as by reducing the time required to perform a cutter-changing operation.
(2) Since the cutter 91 is disposed on the second sliding member 70, and the second sliding member 70 is movable relative to the first sliding member 40, the distance traveled by the first sliding member 40 is shortened. As such, the first and second threaded rods 32, 62 are shorter than the threaded rod 402 (see FIG. 1) of the above-mentioned conventional CNC machine tool. As a consequence, the volume of the CNC machine tool is reduced. Furthermore, the CNC machine tool is manufactured at a low cost.

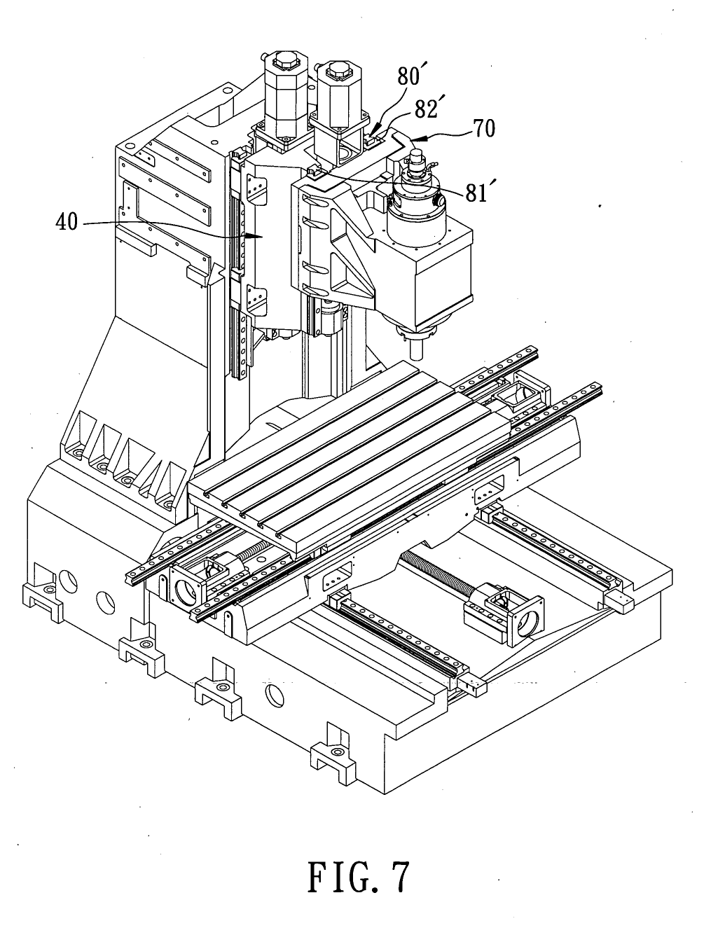

FIG. 7 shows the second preferred embodiment of a CNC machine tool according to this invention, which is similar in construction to the first preferred embodiment except that the second linear rail unit 80′ includes two second slide rails 81′ disposed fixedly on the first sliding member 40, and two second sliding block units disposed fixedly on the second sliding member 70 and slidable respectively along the second slide rails 81′. In this embodiment, each of the second sliding block units consists of two second sliding blocks 82′.

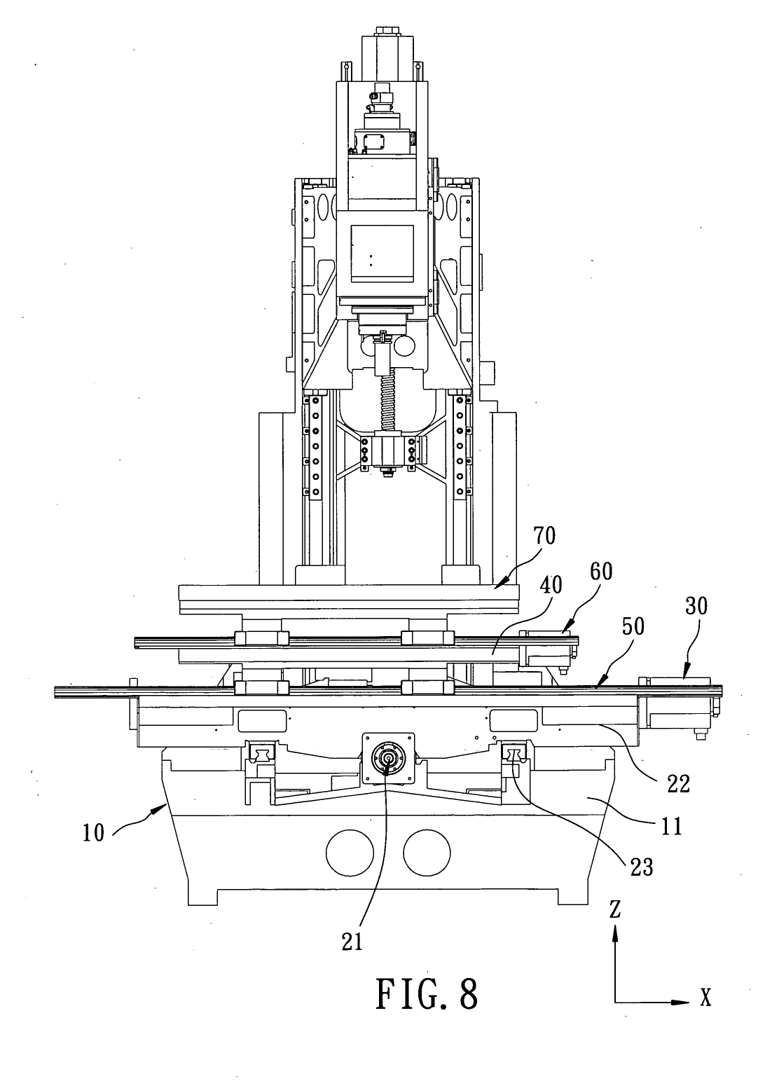

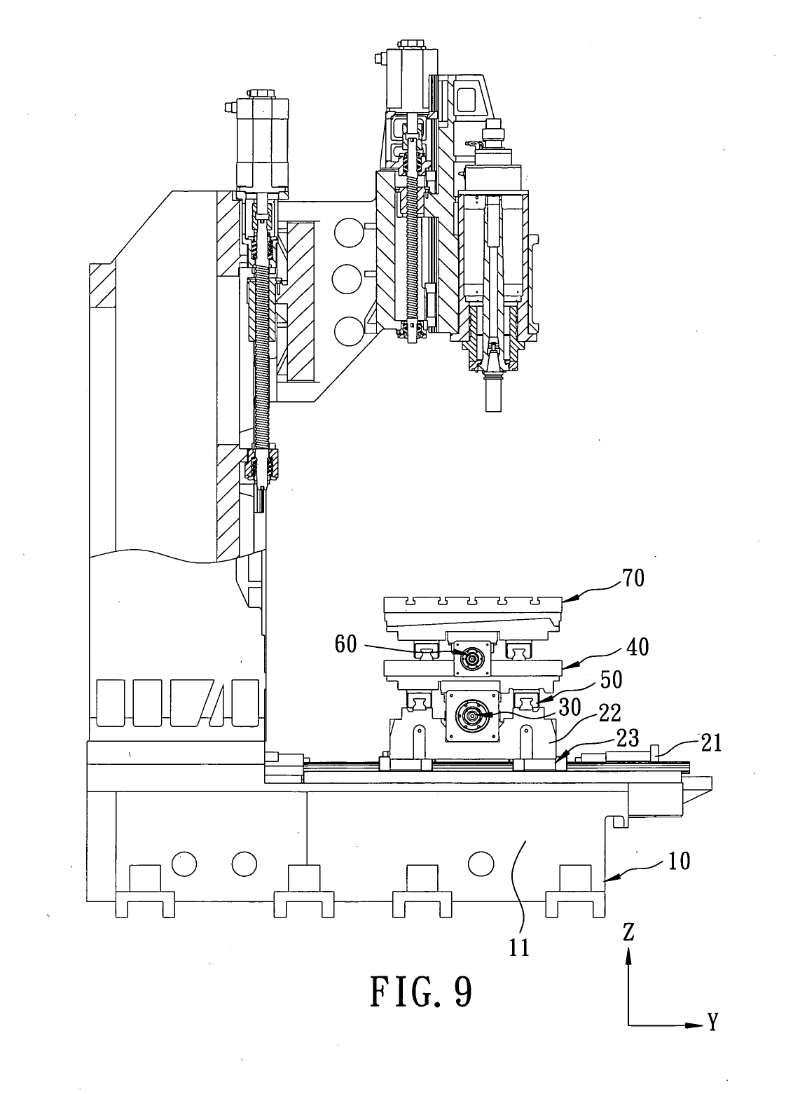

With reference to FIGS. 8 and 9, the third preferred embodiment of a CNC machine tool according to this invention includes a Y-direction driving unit 21 disposed on a bottom seat 11 of a machine body 10, a Y-direction sliding member 22 disposed on the bottom seat 11, a Y-direction linear rail unit 23 disposed between the bottom seat 11 and the Y-direction sliding member 22, a first driving unit 30 disposed on the Y-direction sliding member 22, a first sliding member 40 disposed movably on the Y-direction sliding member 22, a first linear rail unit 50 disposed between the Y-direction sliding member 22 and the first sliding member 40, a second driving unit 60 disposed on the first sliding member 40, a second sliding member 70 disposed movably on the first sliding member 40, and a second linear rail unit 80 disposed between the first and second sliding members 40, 70. The second sliding member 70 is configured as a worktable.

When the first and second driving units 30, 60 are operated simultaneously, the first sliding member 40 is moved on the bottom seat 11 along the X-axis direction at a first speed, and the second sliding member 70 is moved on the first sliding member 40 along the X-axis direction at the first speed. Stated differently, the second sliding member 70 is moved relative to the bottom seat 11 along the X-axis direction at a high, second speed that is double the first speed.

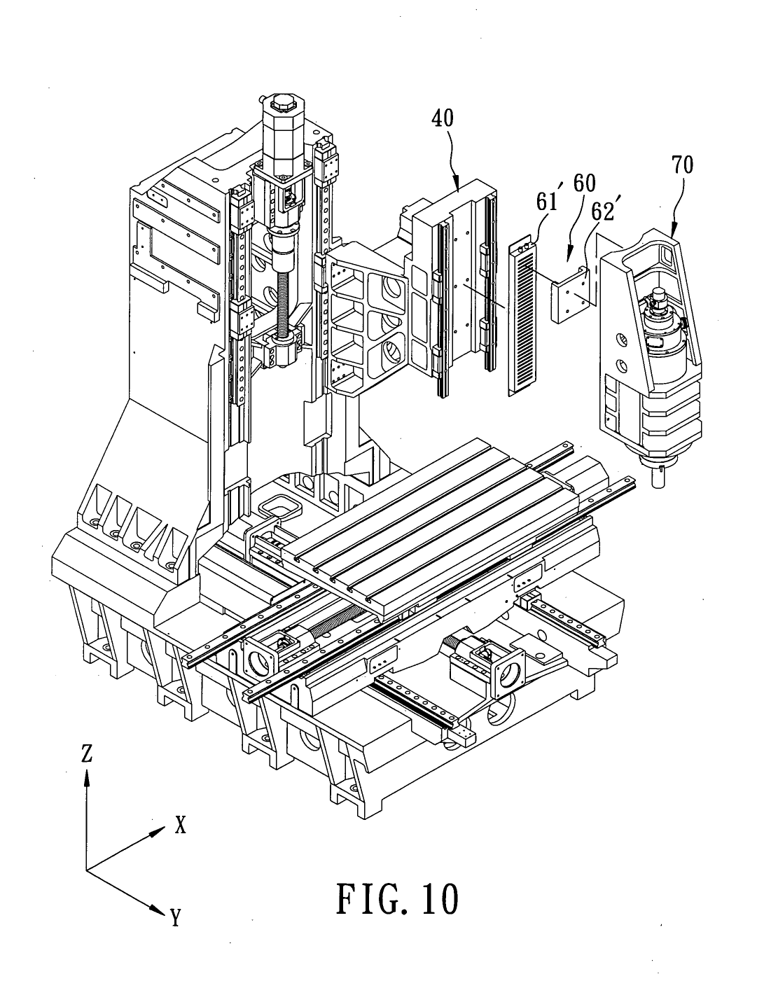

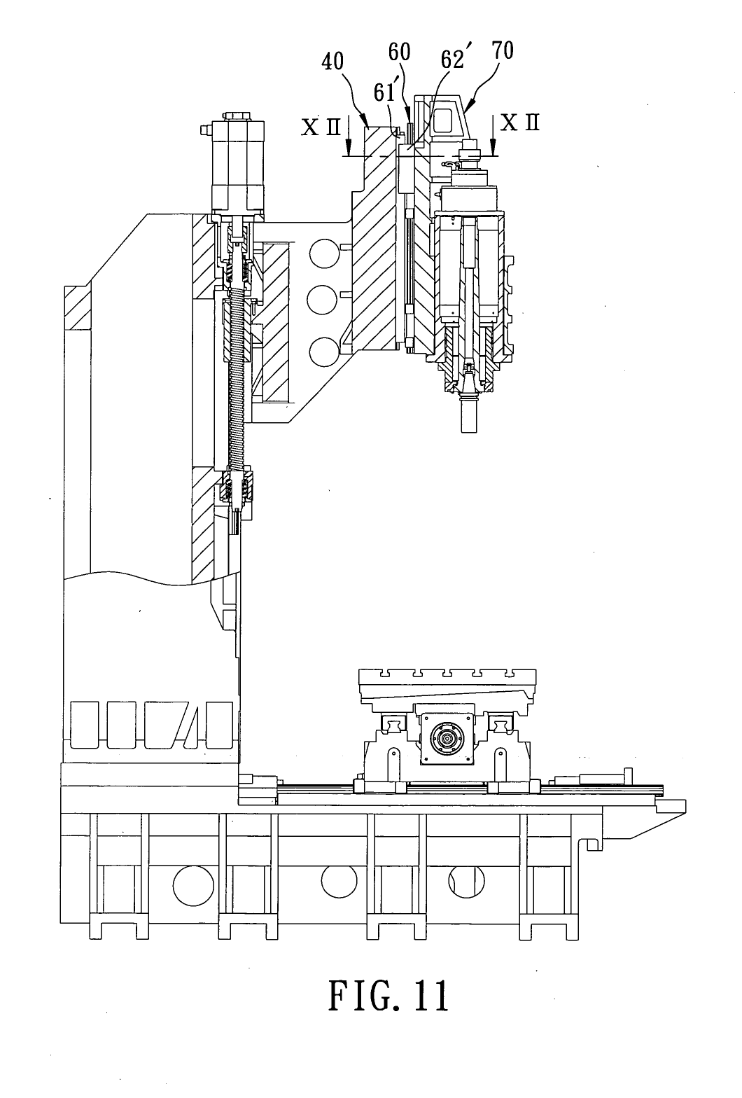

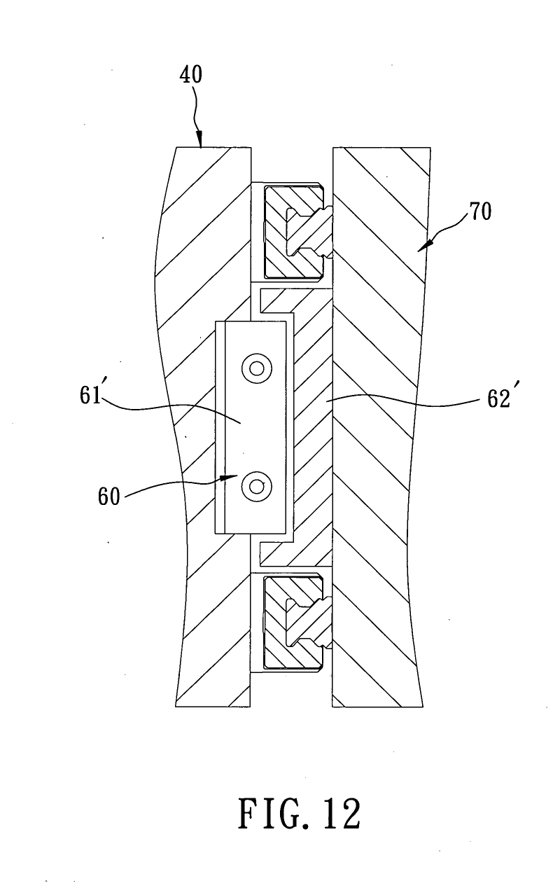

FIGS. 10, 11, and 12 show the fourth preferred embodiment of a CNC machine tool according to this invention, which is similar in construction to the first preferred embodiment except that the second driving unit 60 is configured as a linear motor. The second driving unit 60 includes an elongated stator member 61′ disposed fixedly on the first sliding member 40 and mounted with a plurality of permanent magnets (not shown), and a slider 62′ having a U-shaped cross-section, disposed fixedly on the second sliding member 70, and straddling the stator member 61′. When the linear motor 60 is operated, a magnetic levitation force is generated between the stator member 61′ and the slider 62′ to move the slider 62′ relative to the stator member 61′.

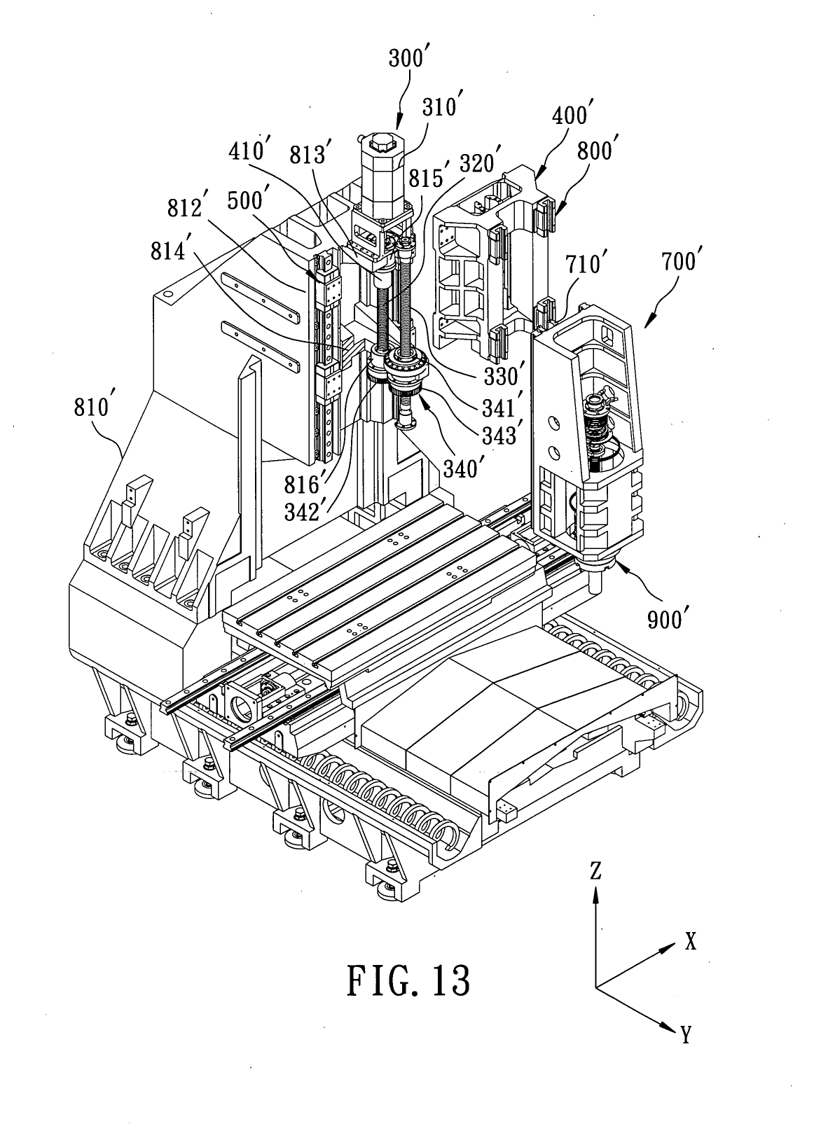

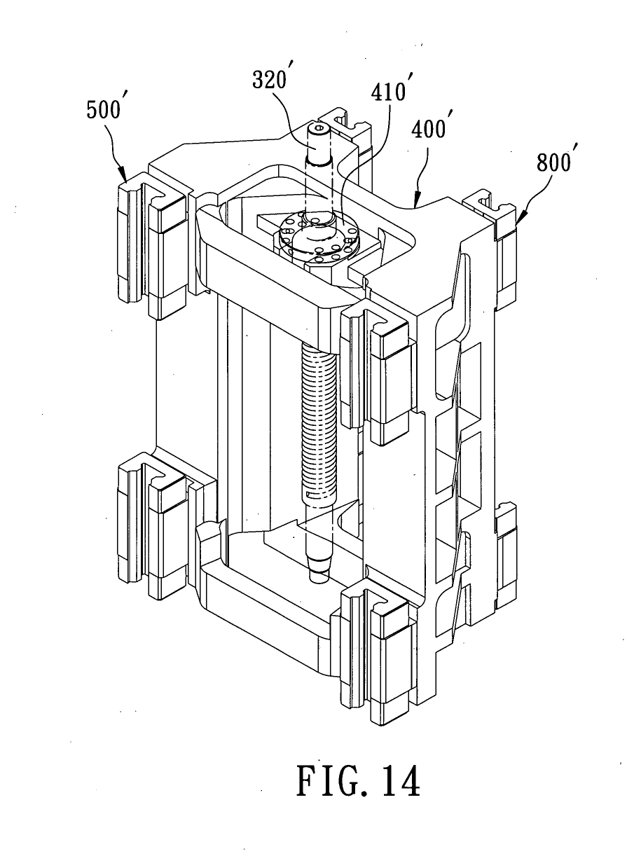

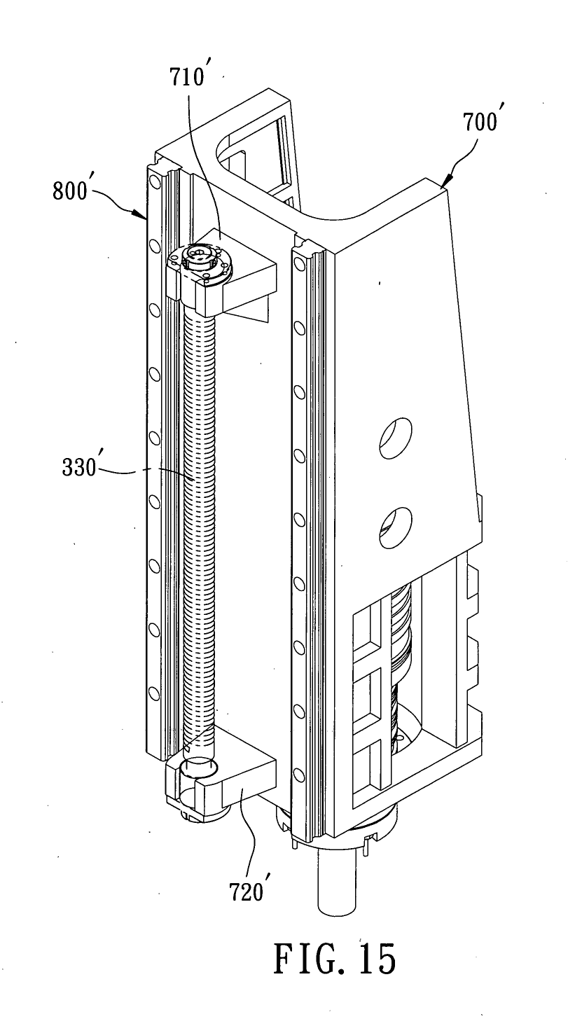

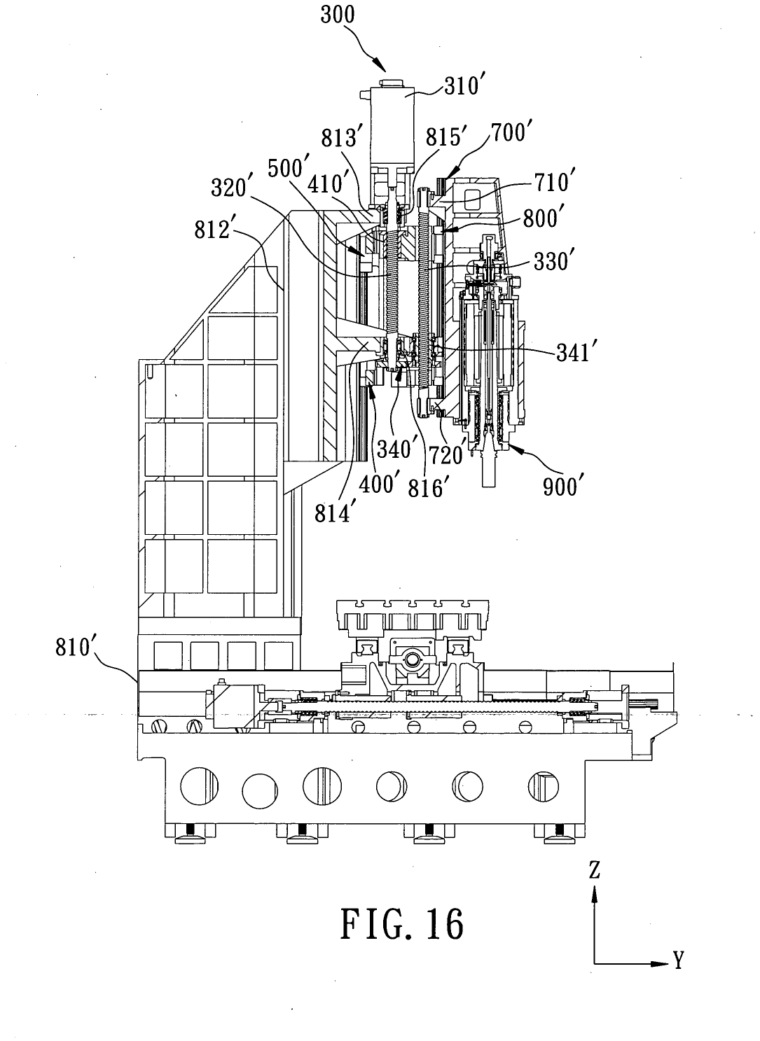

FIGS. 13 to 16 show the fifth preferred embodiment of a CNC machine tool according to this invention, which includes a machine body 810′, a first sliding member 400′, a first linear rail unit 500′, a second sliding member 700′, a second linear rail unit 800′, a spindle unit 900′, and a driving device 300′. The first sliding member 400′ is movable on a post member 812′ of the machine body 810′ along a Z-axis direction. The first linear rail unit 400′ is disposed between the machine body 810′ and the first sliding member 400′. The second sliding member 700′ is movable on the first sliding member 400′ along the Z-axis direction. The second linear rail unit 800′ is disposed between the first and second sliding members 400′, 700′. The spindle unit 900′ is disposed on the second sliding member 700′. The driving device 300 is operable to move the first and second sliding members 400′, 700′.

The machine body 810′ further includes an upper support frame 813′ disposed fixedly on a top end of the post member 812′, and a lower support frame 814′ disposed under the upper support frame 813′. The upper support frame 813′ is mounted with an upper bearing unit 815′. The lower support frame 814′ is mounted with a lower bearing unit 816′ disposed under the upper bearing unit 815′.

The driving device 300′ includes a servomotor 310′ disposed on the upper support frame 813′, a first threaded rod 320′ driven by the servomotor 310′ to rotate on the upper and lower bearing units 815′, 816′, a second threaded rod 330′ parallel to the first threaded rod 320′, and a drive unit 340′ interconnecting said first and second threaded rods 320′, 330′.

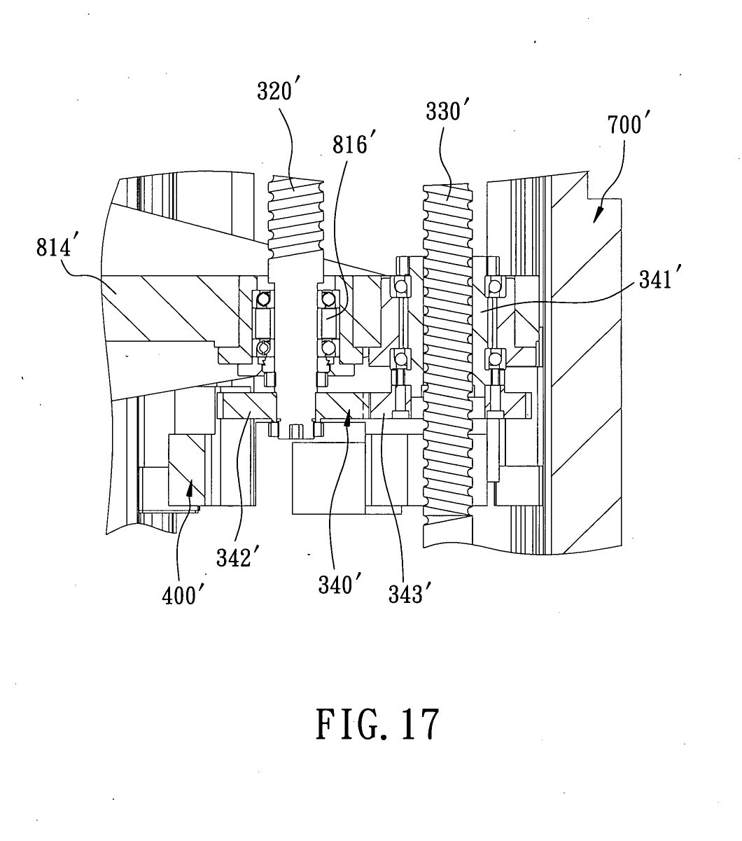

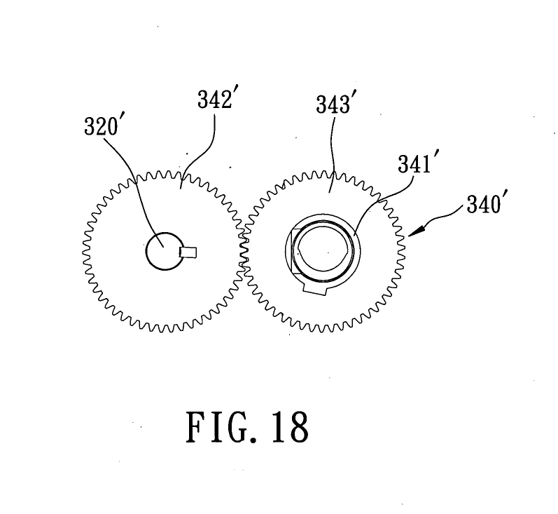

The first and second threaded rods 320′, 330′ extend along the Z-axis direction. One of the first and second threaded rods 320′, 330′ is left-hand threaded, and the other of the first and second threaded rods 320′, 330′ is right-hand threaded. With further reference to FIGS. 17 and 18, the drive unit 340′ includes a nut member 341′ journalled on the machine body 810′ by the lower bearing unit 816′, a first gear 342′ sleeved fixedly on the first threaded rod 320′, and a second gear 343′ sleeved fixedly on the nut member 341′ and meshing with the first gear 342′. The first sliding member 400′ includes a fixed internal thread member 410′ disposed fixedly thereon and engaging threadably the first threaded rod 320′. The second sliding member 700′ has a pair of upper and lower projections 710′, 720′, on which the second threaded rod 330′ is journalled.

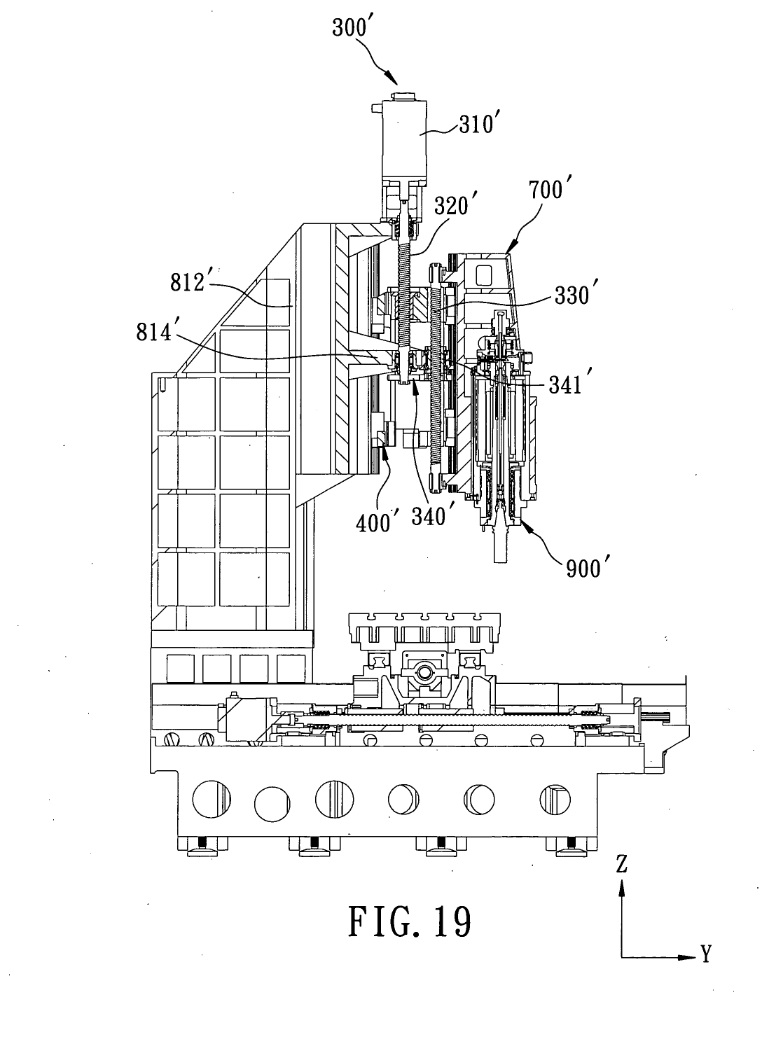

With reference to FIG. 19, when the motor 310′ is operated to rotate the first threaded rod 320′. The first sliding member 400′ moves relative to the post member 812′ along the Z-axis direction, and rotation of the first threaded rod 320′ is transferred to the nut member 341′ by the drive unit 340′, thereby resulting in movement of the second threaded rod 330′ and the second sliding member 700′. As such, the driving device 300′ can drive simultaneous movement of the first and second sliding members 400′, 700′ along the Z-axis direction. Thus, the spindle 900′ can be moved at a high speed.

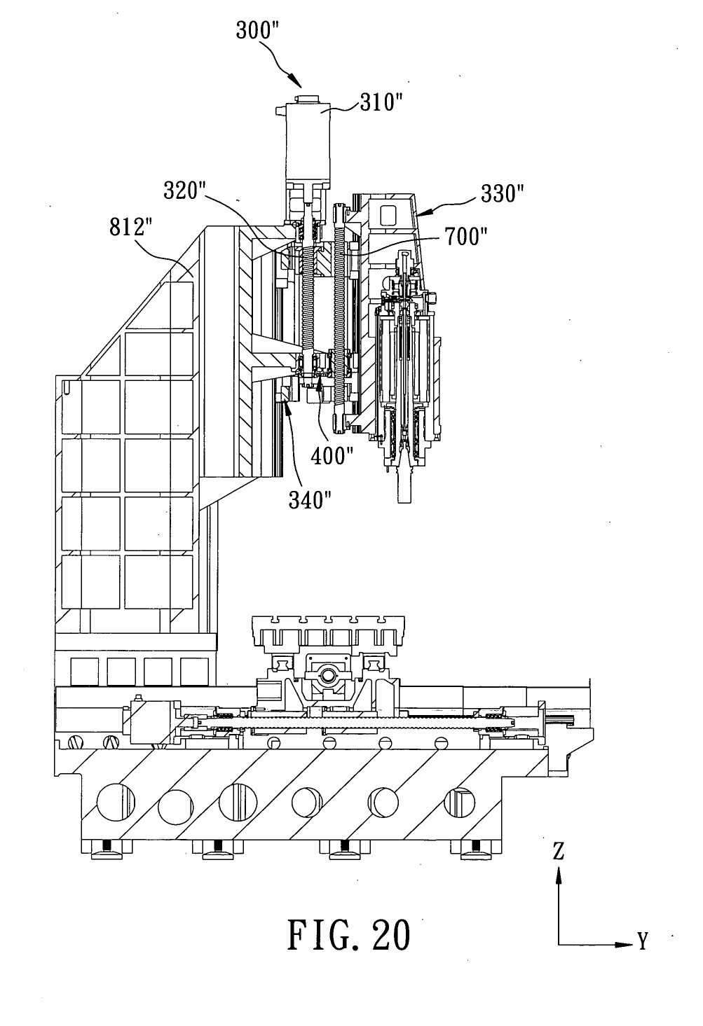

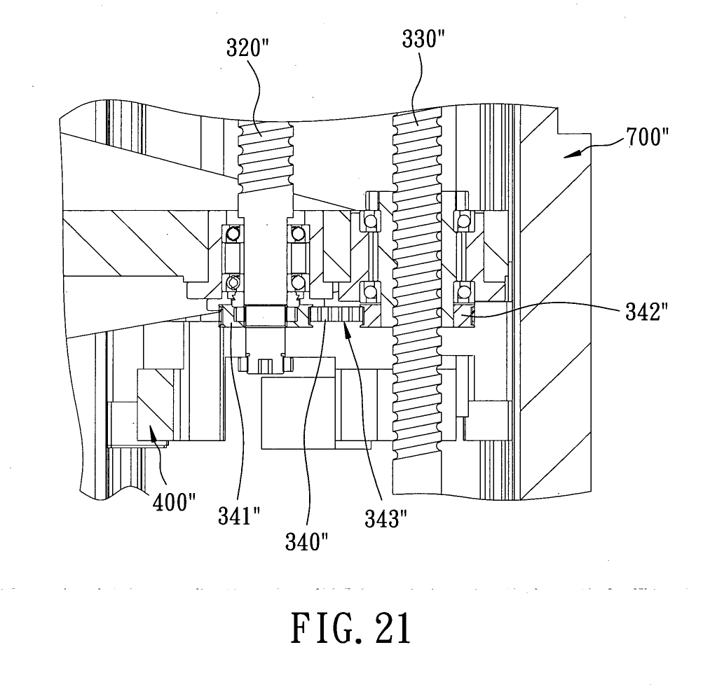

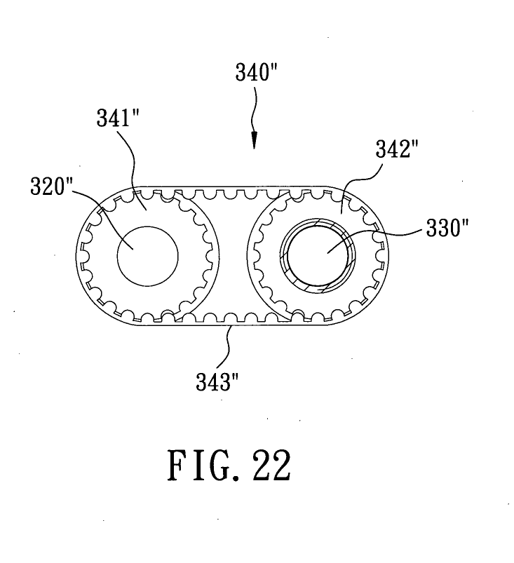

FIGS. 20, 21, and 22 show the sixth preferred embodiment of a CNC machine tool according to this invention, which is similar in construction to the fifth preferred embodiment except for a modified drive unit 340″. The modified drive unit 340″ includes a nut member 341″ journalled on the machine body 810″, a first belt pulley 342″ sleeved fixedly on the first threaded rod 320″, a second belt pulley 343″ sleeved fixedly on the nut member 341″, and a transmission belt 344″ trained on the first and second belt pulleys 342″, 343″. In this embodiment, the first and second threaded rods 320″, 330″ are left-hand threaded. Alternatively, the first and second threaded rods 320″, 330″ may be right-hand threaded.

With this invention thus explained, it is apparent that numerous modifications and variations can be made without departing from the scope and spirit of this invention. It is therefore intended that this invention be limited only as indicated by the appended claims.

I claim:

1. A machine tool comprising:
a machine body;
a first driving unit;
a first sliding member driven by said first driving unit to move on said machine body along a direction;
a second driving unit disposed between said first and second sliding members; and
a second sliding member driven by said second driving unit to move on said first sliding member along said direction.

2. The machine tool as claimed in claim 1, wherein said first driving unit includes a first servomotor and a first threaded rod driven by said first servomotor to rotate on said machine body, said first threaded rod extending along said direction, said first sliding member including a fixed first internal thread member engaging said first threaded rod.

3. The machine tool as claimed in claim 2, wherein said second driving unit includes a second servomotor and a second threaded rod driven by said second servomotor to rotate on said first sliding member, said second threaded rod extending along said direction, said second sliding member including a fixed second internal thread member engaging said second threaded rod.

4. The machine tool as claimed in claim 3, further comprising a first linear rail unit including two first slide rails disposed fixedly on said machine body and extending along said direction, and two first sliding block units disposed fixedly on said first sliding member and slidable respectively along said first slide rails.

5. The machine tool as claimed in claim 4, further comprising a second linear rail unit including two second slide rails disposed fixedly on said second sliding member and extending along said direction, and two second sliding block units disposed fixedly on said first sliding member and slidable respectively along said two second slide rails.

6. The machine tool as claimed in claim 5, wherein said machine body includes a bottom seat and a post member fixed on and extending upwardly from said bottom seat, said direction being a vertical direction, said machine tool further comprising a spindle unit disposed on said second sliding member and extending along said direction.

7. The machine tool as claimed in claim 5, wherein said machine body includes a bottom seat and a post member fixed on and extending upwardly from said bottom seat, said direction being a horizontal direction, said second sliding member being configured as a worktable.

8. The machine tool as claimed in claim 4, further comprising a second linear rail unit including two second slide rails disposed fixedly on said first sliding member and extending along said direction, and two second sliding block units disposed fixedly on said second sliding member and slidable respectively along said second slide rails.

9. The machine tool as claimed in claim 8, wherein said machine body includes a bottom seat and a post member fixed on and extending upwardly from said bottom seat, said direction being a vertical direction, said machine tool further comprising a spindle unit disposed on said second sliding member and extending along said direction.

10. The machine tool as claimed in claim 8, wherein said machine body includes a bottom seat and a post member fixed on and extending upwardly from said bottom seat, said direction being a horizontal direction, said second sliding member being configured as a worktable.

11. The machine tool as claimed in claim 1, wherein said second driving unit is configured as a linear motor including an elongated stator member disposed fixedly on said first sliding member, and a slider disposed fixedly on said second sliding member and straddling said stator member such that a magnetic levitation force is generated therebetween to move said slider relative to said stator member when said linear motor is operated.

12. A machine tool comprising:
a machine body;
a first sliding member movable on said machine body along a direction;
a second sliding member movable on said first sliding member along said direction; and
a driving device including a motor, a first threaded rod extending along said direction and driven by said motor to rotate on said machine body, a second threaded rod parallel to said first threaded rod and disposed movably on said machine body, and a drive unit interconnecting said first and second threaded rods such that rotation of said first threaded rod relative to said machine body results in movement of said second sliding member on said first sliding member along said direction, said first sliding member engaging threadably said first threaded rod so that said motor is operable to drive simultaneous movement of said first and second sliding members on said machine body and said first sliding member, respectively, in the direction.

13. The machine tool as claimed in claim 12, wherein said driving unit of said driving device includes a nut member journalled on said machine body, said second threaded rod of said driving device engaging threadably said nut member and journalled on said second sliding member so that said second threaded rod is movable on said machine body.

14. The machine tool as claimed in claim 13, wherein said driving unit of said driving device further includes a first gear sleeved fixedly on said first threaded rod, and a second gear sleeved fixedly on said nut member and meshing with said first gear, one of said first and second threaded rods being left-hand threaded, the other of said first and second threaded rods being right-hand threaded.

15. The machine tool as claimed in claim 13, wherein said driving unit of said driving device further includes a first belt pulley sleeved fixedly on said first threaded rod, a second belt pulley sleeved fixedly on said nut member, and a transmission belt trained on said first and second belt pulleys, said first and second threaded rods being left-hand threaded.

16. The machine tool as claimed in claim 13, wherein said driving unit of said driving device further includes a first belt pulley sleeved fixedly on said first threaded rod, a second belt pulley sleeved fixedly on said nut member, and a transmission belt trained on said first and second belt pulleys, said first and second threaded rods being right-hand threaded.
